(19) United States
(12) Patent Application Publication
(10) Pub. No.: US 2016/0189135 A1
(43) Pub. Date: Jun. 30, 2016

(54) VIRTUAL CHIP CARD PAYMENT

(71) Applicant: CA, Inc., Islandia, NY (US)

(72) Inventors: Geoffrey R. Hird, Cupertino, CA (US); Rammohan Varadarajan, Cupertino, CA (US)

(21) Appl. No.: 14/092,900

(22) Filed: Nov. 27, 2013

(51) Int. Cl. G06Q 20/32

(52) U.S. Cl. CPC G06Q 20/3227

(57) ABSTRACT

Data is received that corresponds to an image presented at a location of a transaction involving a user device and a terminal device. It is determined that the user device and the terminal device are engaged in the transaction based at least in part on the data and local interactions of a payment device with the terminal device are virtualized based on authenticating the transaction. Virtualizing the interactions can include exchanging messages with the terminal device over a network according to a protocol corresponding to the payment device and the terminal device.

### BACKGROUND

The present disclosure relates in general to the field of electronic payment systems, and more specifically, to emulating card-based payments.

The card payment industry has introduced support for some cardholders to pay at a merchant's point-of-sale (POS) terminal device using a near field communications (NFC)-enabled mobile phone. For instance, the Europay, MasterCard, and Visa (EMV) consortium has defined standards that individual card brands have used as a basis for their own derived specifications. Such mobile phones can store the card data and associated algorithms in a hardware chip called a “Secure Element” that is located in the phone. The card data and algorithms are the same as those stored in an EMV-style “chip card”, which is a plastic card with an embedded chip that can be used complete transactions using NFC. In the mobile phone version, even though there is no plastic card, the industry still uses the word “card”. In keeping with this terminology, “card” can also refer to a payment credential and accompanying logic residing in an NFC-enabled device, such as a smartphone, that enables the device to function as a traditional chip card or other payment device. During a transaction, an NFC-enabled device is held an inch or so from the POS terminal, and the terminal and the payment device communicate over NFC to complete the transaction.

### BRIEF SUMMARY

According to one aspect of the present disclosure, data can be received that corresponds to an image presented at a location of a transaction involving a user device and a terminal device. It can be determined that the user device and the terminal device are engaged in the transaction based at least in part on the data and local interactions of a payment device with the terminal device can be virtualized based on authenticating the transaction. Virtualizing the interactions can include exchanging messages with the terminal device over a network according to a protocol corresponding to the payment device and the terminal device.

### BRIEF DESCRIPTION OF THE DRAWINGS

FIG. 1 is a simplified schematic diagram of an example computing system including an example virtual card server system in accordance with at least one embodiment;

FIG. 2 is a simplified block diagram of an example computing system including an example virtual card server system, an example virtual card payment application, and an example terminal device in accordance with at least one embodiment;

FIG. 3 is a simplified flow chart of an electronic payment protocol in accordance with at least one embodiment;

FIGS. 4A-4B are simplified block diagrams illustrating example payment using a virtual card in accordance with at least some embodiments;

FIG. 5 is a simplified block diagram illustrating an example payment using a virtual card in accordance with at least some embodiments;

FIGS. 6A-6E are simplified flowcharts illustrating example techniques in connection with payment using a virtual card in accordance with at least some embodiments.

Like reference numbers and designations in the various drawings indicate like elements.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely in hardware, entirely software (including firmware, resident software, micro-code, etc.) or combining software and hardware implementations that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, CII, VB.NET, Python or the like, conventional procedural programming languages, such as the “C” programming language, Visual Basic, Fortran 2003, Peri, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

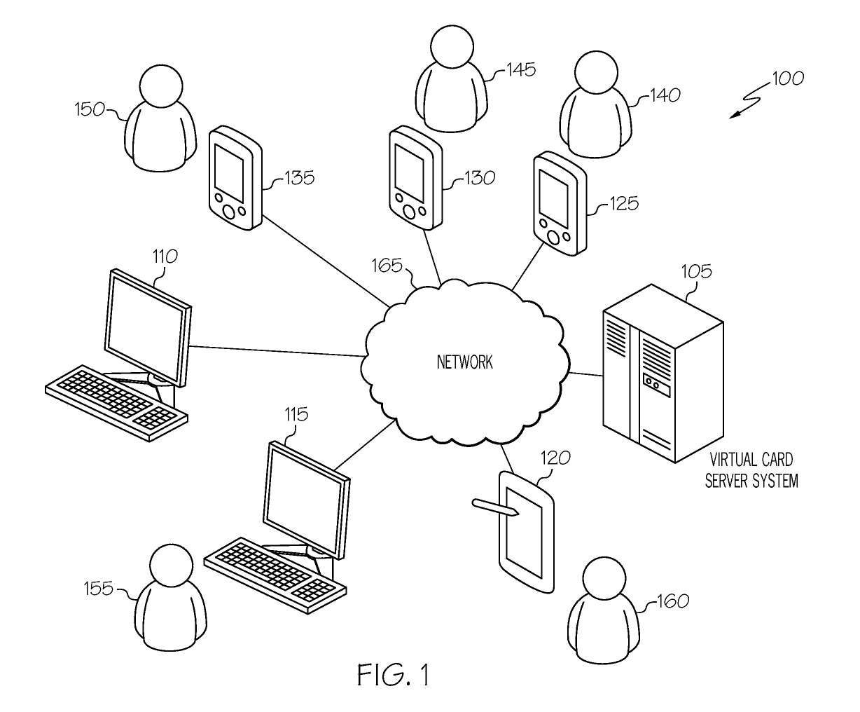

Referring now to FIG. 1, FIG. 1 is a simplified block diagram illustrating an example computing environment 100 including a virtual card payment system 105, terminal systems (such as point-of-sale (POS) terminals) 110, 115, 120, and user devices 125, 130, 135 equipped with functionality for submitting payment in transactions at terminal devices 110, 115, 120. In one example, personal communications devices (or “user devices”) 125, 130, 135 can each be associated with one or more users (e.g., 140, 145, 150). User information can be stored on the user devices 125, 130, 135, for instance, through a subscriber identity module (SIM), digital payment account information, secure elements, and other modules and storage. A user (e.g., 140, 145, 150) can present their device at a terminal device (e.g., 110, 115, 120) in some cases managed by users (e.g., 155, 160) employed by a store or other enterprise to conduct the transaction with the users 140, 145, 150. Terminal devices (e.g., 110) can also include unmanned, automated terminal systems, such as kiosks and other systems. Information, such as image data, can be communicated between the user devices (e.g., 125, 130, 135) and terminal devices (e.g., 110, 115, 120) and the information can be used to authenticate the transaction by coordinating with virtual card payment system 105 over one or more networks (e.g., 165). The virtual card payment system 105 can emulate transaction protocols between a traditional payment card, such as a chip card or digital payment system on a user device, and the terminal system (e.g., 110, 115, 120), among other examples. Further, user devices (e.g., 125, 130, 135) can be used to manage various aspects of user's (e.g., 140, 145, 150) transactions and payment accounts involving virtual card payment system 105 by interfacing with the virtual card payment system over networks 165 through applications or utilities of user devices 125, 130, 135, among other examples.

In general, “servers,” “user devices,” “mainframes”, “computing devices,” “network elements,” “hosts,” “clients,” “communication devices,” “computers,” and “systems,” etc. (e.g., 105, 110, 115, 120, 125, 130, 135, etc.) in example computing environment 100, can include electronic computing devices operable to receive, transmit, process, store, or manage data and information associated with the computing environment 100. As used in this document, the term “computer,” “processor,” “processor device,” or “processing device” is intended to encompass any suitable processing device. For example, elements shown as single devices within the computing environment 100 may be implemented using a plurality of computing devices and processors, such as server pools including multiple server computers. Further, any, all, or some of the computing devices may be adapted to execute any operating system, including Linux, UNIX, Microsoft Windows, Apple OS, Apple iOS, Google Android, Windows Server, etc., as well as virtual machines adapted to virtualize execution of a particular operating system, including customized and proprietary operating systems.

Further, servers, clients, network elements, systems, and computing devices (e.g., 105, 110, 115, 120, 125, 130, 135, etc.) can each include one or more processors, computer-readable memory, and one or more interfaces, among other features and hardware. Servers can include any suitable software component or module, or computing device(s) capable of hosting and/or serving software applications and services, including distributed, enterprise, or cloud-based software applications, data, and services. For instance, in some implementations, virtual card payment system 105, or other system or subsystem of an example computing environment (e.g., 100) can be at least partially (or wholly) cloud-implemented, web-based, or distributed to remotely host, serve, or otherwise manage data, software services and applications interfacing, coordinating with, dependent on, or used by other services and devices in environment 100. In some instances, a server, system, subsystem, or computing device can be implemented as some combination of devices that can be hosted on a common computing system, server, server pool, or cloud computing environment and share computing resources, including shared memory, processors, and interfaces.

While FIG. 1 is described as containing or being associated with a plurality of elements, not all elements illustrated within computing environment 100 of FIG. 1 may be utilized in each alternative implementation of the present disclosure. Additionally, one or more of the elements described in connection with the examples of FIG. 1 may be located external to computing environment 100, while in other instances, certain elements may be included within or as a portion of one or more of the other described elements, as well as other elements not described in the illustrated implementation. Further, certain elements illustrated in FIG. 1 may be combined with other components, as well as used for alternative or additional purposes in addition to those purposes described herein.

A payment device can be a device that hosts or otherwise possesses computer-implemented functionality of a card or other electronic payment instrument (sometimes referred to herein collectively as “payment instrument”). A payment instrument can be hosted in memory of one or more payment devices and embodied as electronic payment logic and credentials, account information, and other data used by the payment logic to process and generate messages exchanged with a terminal in a transaction. A payment device can potentially host multiple payment instruments (e.g., one for each account associated with a user/owner of the payment device). Similarly, in some cases, instances of a payment instrument for an account can be hosted on multiple different devices (e.g., each of a plurality of devices owned by the account holder). A payment device can be used at a merchant point-of-service device, kiosk, automated teller machine (ATM), or other terminal system and communicate data with the terminal to complete a transaction. While much of the discussion herein references examples involving terminal systems and transactions, it should be appreciated that the concepts discussed herein also pertain to other systems supporting the use of payment cards.

During a transaction in which a payment instrument (e.g., hosted by a payment device) is used by a user to withdraw money, purchase a good or service, etc. or otherwise engage in a transaction with another party, a terminal device, such as a point-of-sale (POS) terminal, and the payment device can exchange several messages and negotiate whether the transaction will be performed, and if so, how it will be performed. A variety of protocols can be utilized to define the exchange of messages and the negotiation between a terminal and the card. One such example is the Europay, MasterCard, Visa (EMV) standard, although a wide array of other standards can also be used, including variants of EMV and other standards.

It has been shown that sophisticated antennae and signal processing tools can be utilized to intercept transmissions over an NFC channel between a payment device (e.g., using a hosted payment instrument) and a terminal device. These intercepted transmissions can pose an unacceptable security risk to the holders of the card or other payment instrument, with malicious individuals capable of using the captured transmissions to collect and misuse sensitive personal and financial information, among other potential issues.

In traditional payment devices, sensitive card data is attempted to be secured on the device within a Secure Element (SE), which can include a tamper-resistant chip that has both a processor and storage and stores logic for performing the functionality of a chip card. Such implementations require both algorithms and data, and these are both stored within the SE. The SE's add to the cost of a device and are not universally included in hardware of all mobile devices. Moreover, various actors such as the device seller, the carrier, and the operating system provider, may control or block access to the SE, limiting its utility, among other potential issues in previous systems.

In one example, a virtual card system can be provided that addresses at least a portion of the issues introduce above, among others. For instance, a virtual card system can utilize a remotely-provided virtual card server hosting an instance of a “virtual card” payment instrument that can conduct various steps of protocols used in traditional card transactions over one or more secure network connections. Such a system can apply to a variety of protocols including variants of the EMV standard, magstripe style protocols, and other variants not yet codified. Further, a virtual card system can apply to a variety of transactions to including transactions at retail POS terminals, ATM transactions, unattended kiosk transactions, and others. In some implementations, a user device can interact with a terminal to trigger an exchange between the terminal and a remote “virtual card” associated with the user. The virtual card can emulate an exchange with the terminal as if it were a locally presented card using a protocol supported by the terminal. The emulated exchange can appear to the terminal device as the same as a local exchange except for the connection mechanism (and the fact that the virtual card is remotely hosted and not (necessarily) local to the terminal). This can provide enhanced security for digital transactions, for instance, because the terminal-to-server network channel can use secure socket layer (SSL) or other encryption, unlike the unencrypted NFC channels used in traditional terminal-to-payment device communications, among other example advantages. Further, a virtual card system can allow not only the bona fides of the user/card holder to be proven to a merchant, but the merchant's bona fides can also be proven, guarding the user against unscrupulous merchants, among other potential example advantages.

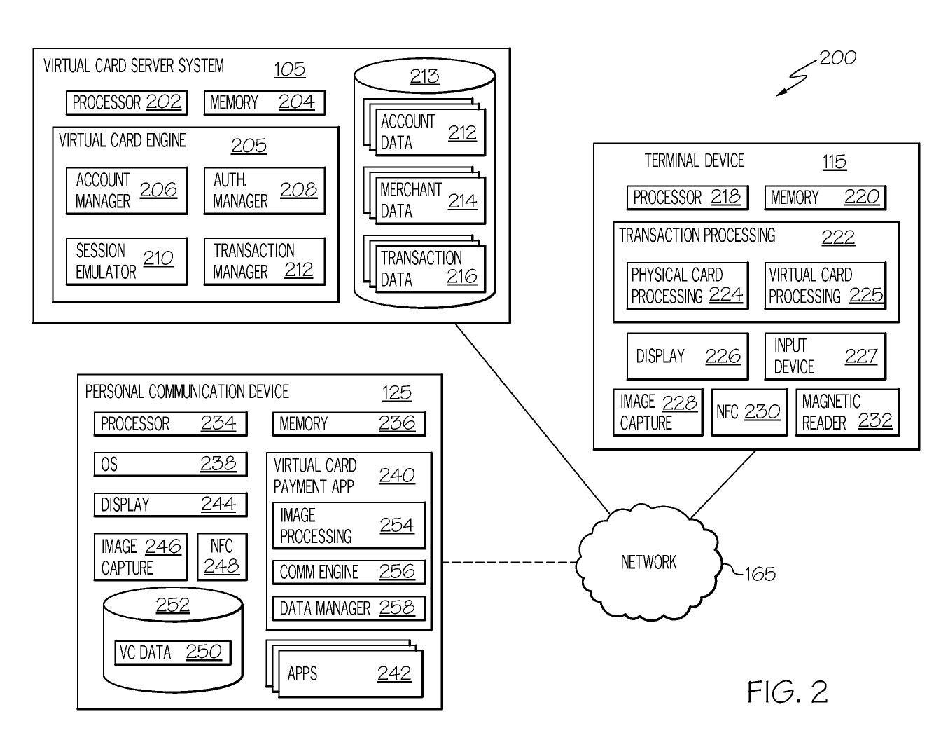

Turning now to the simplified block diagram of FIG. 2, an example implementation of a virtual card system 200 is illustrated including an example virtual card payment system server 105, one or more personal communication devices (or user devices) (e.g., 125), and one or more terminals (e.g., 115). In one example, virtual card payment system 105 can include one or more data processing apparatus 202, one or more memory elements 204, and computer executable logic embodied, in some instances, in one or more software and/or hardware-based components, including, for example, a virtual card engine 205. In the particular example of FIG. 2, virtual card engine 205 can be adapted to interface with user devices (e.g., 125), such as smart phones, tablet computers, personal laptop and desktop computers, dedicated chip card devices, among other examples, as well as terminal devices (e.g., 115), over one or more networks 165. In one example, virtual card engine 205 can include subcomponents such as an account manager 206, authentication manager 208, session emulator 210, and transaction manager 212, among other subcomponents and alternatives. An account manager 206 can manage multiple card holder accounts together with account data 212 in one or more data stores (e.g., 213). Account data 212 can include records of account numbers, sponsoring financial institutions, user name and personal information, information identifying the computing device(s) or virtual card payment application installation(s) associated with the card holder, image encoding and other account-identifying data associated each respective account. In some cases, authenticated card holders can interface with account manager 206 using, for instance, user device 125, and update the card holder's personal information, associate a virtual card with a financial institution, view recent and pending transactions, among other account management activities. Account manager 206 can modify account data 212 (and in some cases transaction data 216) based on user-provided information and feedback.

Account manager 206, in some implementations, can additionally manager merchant data records 214 identifying merchants that have been involved in transactions with holders of virtual cards supported by virtual card payment system 105. In some cases, at least some merchants identified in merchant data 214 can be considered authorized or trusted merchants. In some cases, virtual card payment system 105 can also support transactions with merchants not (yet) included or recognized as trusted merchants and can assess and associate reputation scores for the merchants as well as collect information from the merchants that can be used to authenticate the merchants or indicate to users a level of trust associated with a given merchant. In this manner, card holders can receive feedback regarding the level of security involved in transacting with a particular merchant. Merchant data 214 can be used to compare information obtained by the virtual card payment system 105 from a terminal (e.g., 115) in a transaction to attempt to authenticate or at least identify the merchant involved in the transaction, among other uses and examples.

An example virtual card payment system 105 can further include an authentication manager 208 configured to authenticate a transaction before passing the handling of the transaction to session emulator 210. In one example, a user device (e.g., 125) can trigger a virtual card transaction by passing authentication data to a terminal device (e.g., 115). The authentication data can encode a key and/or identifier associated with a particular card holder account. Terminal device 115 can identify that the transaction is to involve a virtual card hosted by virtual card payment system (e.g., 105) and send the authentication data to the virtual card payment system 105 along with other transaction data identifying the merchant, the amount of the transaction, other transaction descriptor data, and other information. The authentication manager 208 can decode the authentication data to determine if the authentication data is authentic and corresponds to one of the accounts managed by the virtual card payment system 105. In other implementations, authentication manager 208 can be triggered to send authentication data to the terminal device 115 which the terminal device is to then pass to the user device 125 associated with a particular card holder's account. The user device 125 can relay the authentication data received from the terminal device 115 back to the virtual card payment system 105 for use by the authentication manager 208 in authenticating a transaction between a given card holder (using a supported card-holder-associated device (e.g., 125)) and merchant associated with a given terminal device (e.g., 115), among other potential examples.

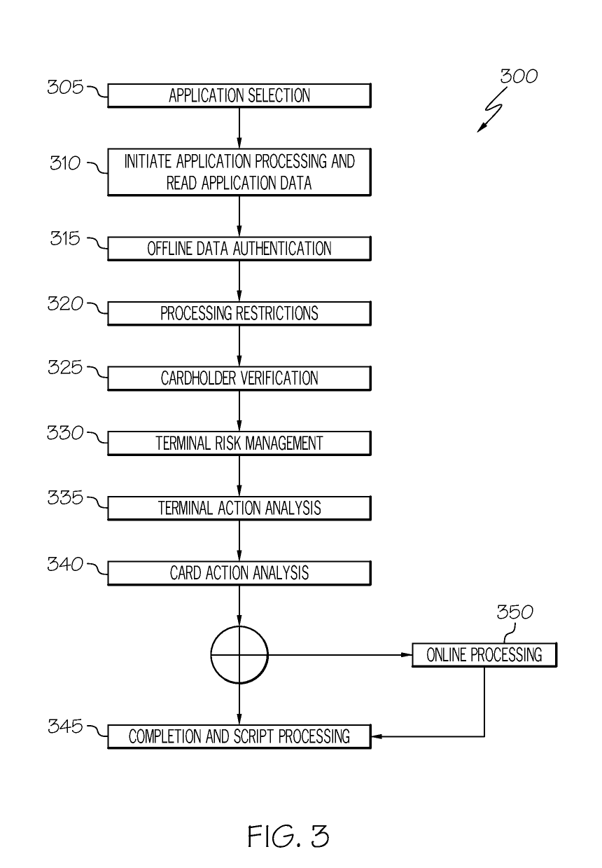

Upon authenticating that a legitimate card holder is in the presence of and completing a transaction with a given terminal device, session emulator 210 can interact with terminal device over one or more networks 165 to emulate an exchange of messages associated with a particular electronic payment protocol, such as a protocol between a chip card or magstripe card and a local reader on the terminal device. In some implementations, session emulator 210 can emulate an EMV protocol exchange, such as illustrated in the example of FIG. 3. While the example of FIG. 3 shows an EMV-style protocol flow, it should be appreciated that this particular flow is presented as an example only and does not limit the applicability of the principles described here to any other electronic payment protocol defined and supported by the session emulator (e.g., 210) and a terminal device (e.g., 115).

As shown in the simplified flowchart 300, a protocol exchange between a session emulator (e.g., 210) and terminal system (e.g., 115, or a backend system supporting terminal device 115) can be emulated. In some cases, multiple applications (such as multiple EMV applications) may be supported—for a given card and the protocol can include selection (at 305) of a particular one of the applications. The - card emulated by the session emulator (e.g., 210) (e.g., the virtual card) can negotiate and agree upon a common supported application and choose which to use for the transaction. In some cases, selection of the application to be used in the transaction can involve a user (e.g., of the communication device (e.g., 125)) being prompted for a selection that is to be communicated to the virtual card payment system 105 and, in turn, the terminal system (e.g., 115). The selected application can be initiated (at 310) and application data can be provided from the virtual card (e.g., over network 165 from the virtual card payment system 105) to the terminal system for use by the terminal system. Offline data authentication 315 can then be performed to validate the virtual card using, for instance public-key cryptography. One or more of multiple available cryptographic checks can be performed including: static data authentication (SDA) to ensure data read from the card has been signed by the card issuer; dynamic data authentication (DDA) to protect against modification of data and cloning; and combined DDA/generate application cryptogram (CDA) to assure card validity, among other potential example techniques.

Restrictions can be processed (at 320) to confirm that the virtual card is allowed to do the requested transaction. Application data can be checked in connection with restriction processing 320 including the application version number, application usage control (e.g., whether the card is geographically restricted, etc.), application effective or expiration date(s), etc. Cardholder verification (at 325) can also be performed to verify the cardholder. A mechanism supported by the terminal system for verifying the cardholder can be agreed upon between the virtual card emulated by the emulation engine and the terminal system, such as a user signature, online PIN entry, offline enciphered PIN, offline plaintext PIN, “no CVM”, among other examples. Terminal risk management (at 330) can be performed to conduct one or more checks to determine whether a transaction should be authorized online or offline. Such checks can include, for example, checking floor limit, among other examples. Based on results of offline data authentication, processing restrictions, cardholder verification, terminal risk management and rules in the terminal and from the chip, terminal action analysis can be performed (at 335) and the terminal can request a result of decline offline, approve offline, or go online, among other examples. Card action analysis can also be performed (at 340) based on virtual card issuer defined rules and limits and a response can be issued such as go online, offline decline, offline approval, etc. In the case of offline approval, for instance, the transaction can proceed to completion (at 345). In the case that the transactions goes online, online processing can be performed (at 350) before proceeding to transaction completion 345. Online processing 350 can include the terminal building an online request to the virtual card issuer host for authorization and online card authentication. In some cases, a response can include optional issuer authentication and the terminal system can send the data to the virtual card for verification. Further, it should be appreciated that other protocol steps including variants of the foregoing can be included or substituted for those examples discussed above.

Returning to the discussion of the example of FIG. 2, virtual card payment system 105 can include a session emulator 210 capable of emulating a variety of—card payment applications, among other features and data for use in a protocol such as that described in connection with the example of FIG. 3. In some cases, virtual card engine 205 can additionally include a transaction manager 212 capable of managing transaction data received in connection with the exchange of messages and information between a card emulated by session emulator 210 and a terminal system. In some cases, transaction manager 212 can manage additional aspects in connection with or following completion of transactions involving the virtual card, among other examples.

An example terminal device (e.g., 115) can include one or more data processing apparatus 218, one or more memory elements 220, as well as one or more computer executable logic embodied, in some instances, in one or more software and/or hardware-based components, including, for example, a transaction processing engine 222, among other examples. In one example, transaction processing engine 222 can include physical card processing engine 224 for processing transactions with physical cards presented locally at the terminal device 115, such as chip cards and magstripe cards as well as virtual card processing engine 225 to enable the transaction processing engine 222 to complete transactions with virtual cards remotely provided through one or more virtual card payment services (such as one hosted by virtual card payment system 105). A terminal device can detect the form of payment/withdrawal used for instance based on an input of a customer or detecting and/or communicating with the card or device used by the customer in the transaction. In other instances, a human operator of the terminal device 115 can input the type of card used in the transaction causing either physical card processing 224 or virtual card processing 225 logic to be invoked and used in the transaction.

In the case of a virtual card processing engine 225, multiple types and supported protocols of virtual cards can be supported by the virtual card processing engine 225. For instance, multiple different virtual card payment systems may exist (including 105) and the terminal device 115 may be equipped so as to flexibly handle transactions involving anyone of a priority of different virtual card payment systems, among other examples. Terminal system 115 can communicate with a virtual card payment system 105 over one or more networks (e.g., 165), as introduced above. The terminal system can communicate authentication data to the virtual card payment system 105, in some instances, or a personal communicate device, in other instances, in connection with authentication of a transaction using a particular virtual card hosted by the virtual card payment system 105. The terminal system can further exchange communications with the virtual card payment system 105 in connection with one or more protocols emulating protocols between the terminal device and local card payment mechanisms, such as EVM chip cards and other examples.

A terminal device 115 can include various components to assist the terminal device in gathering and using information in connection with both local card transactions and virtual card transactions. For instance, terminal device 115 can include or be connected to a magnetic strip reader 226 (e.g., for reading a magstripe card), a near-field communication module 230 (e.g., for communicating with a local chip card or communication device embodying a chip card), as well as include other functionality for use in transactions involving some implementations of virtual card payment systems (e.g., 105).

A user device 125 can also include one or more data processing apparatus 234, one or more memory elements 236, as well as one or more computer executable logic embodied, in some instances, in one or more software and/or hardware-based components, including, for example, a virtual card payment application 240, among other examples. The user device 125, in one example, can further include an operating system 238 and one or more other applications 242 and programs. Other features can be provided for use in connection with virtual card payment application 240 such as a display device 244, such as a touchscreen or other display, and image capturing device 246, such as an integrated digital camera, among other examples. In some implementations, user device 125 can possess functionality to allow the device 125 to be adapted for other electronic payment schemes such as use as a traditional NFC card through a secure element (not shown) and a NFC module 248, among other examples. User device 125 can also include functionality for connecting, via wired or wireless communication channels, to one or more networks 165.

In one example, virtual card payment application 240 can include subcomponents such as an image processing engine 254, communication engine 256, and data manager 258, among other examples or alternatives. In one implementation, image processing engine 254 can be provided in connection with the triggering of a virtual card transaction at a terminal (e.g., 115). The image processing engine 254 can generate image data for presentation to the terminal device. The image data can be generated such that at least a portion of the image data varies from transaction to transaction (e.g., randomly) and another portion is encoded to identify the user device, a particular virtual card account, cardholder, or other information that can be decoded by virtual card payment system 105. Information encoded in the image data can further include such examples as the identity of the merchant on the other side of the transaction, the amount of the transaction, among other examples. In some implementations, the version of the image data can be generated such that it is a version expected for a next transaction involving a particular virtual card account. For instance, a counter value can be consulted (e.g., in virtual card data 250) by image processing engine 240 to determine or generate particular image data for a given transaction. The image data can be used to authenticate that a particular terminal device is legitimately transacting with an authorized user device (e.g., including virtual card data 250 and a virtual card payment application 240 installation associated with a valid virtual card account). Virtual card data 250 can be stored in secured memory or data structures (e.g., 252) and, in some cases, may only be accessed by a corresponding virtual card payment application installation.

In some implementations, virtual card payment application 240 can trigger and generate authentication image data for a virtual card transaction even when the user device is offline, allowing for use of the virtual card payment mechanism even in environments when network connectivity is unavailable, limited, or disallowed. In other instances, virtual card payment application 240 can include a communication engine 256 for use in interfacing with and interoperating with virtual card server system 105 over one or more networks (e.g., 165) in connection with some virtual card transactions. In some instances, communication engine 256 can include or utilize certificates, keys, encryption, one-time-passwords, or other authentication schemes and mechanisms to participate in secured, mutually authenticated communications with virtual card server system 105. Data can be received from virtual card server system 105, in some implementations and a data manager 258 can manage virtual card data 250 in accordance with operation of the virtual card payment application 240 and communications received from virtual card server system 105, among other examples.

As introduced above, in some examples, image data can be shared between a terminal device and a user device 125 in connection with authentication of a virtual card transaction. In one implementation, a user device (e.g., 125) associated with a virtual cardholder account can present an image to the terminal device 115 and image capturing device 228 on the terminal device can capture, and in some cases, at least partially interpret the image data presented by the user device. A virtual card server system 105 associated with an attempted payment using a virtual card can be identified, for instance, automatically from the image data or manually by a user of the terminal device 115. The terminal device 115 can communicate with the corresponding virtual card server system 105 to indicate that a transaction using a particular virtual card has been triggered by a user device 125. The terminal device 115 can provide transaction information to the virtual card server system 105 describing aspects of the transaction, such as the identity of the merchant, the amount involved in the transaction, etc. and can further transmit the received image data as captured by the terminal device 115. The virtual card server system 105 can determine whether the image data is authentic and, if so, further identify a corresponding virtual card account associated with the image data. The virtual card server system 105 can then emulate the behavior of a chip card or other payment device (and its payment instrument) according to one or more protocols supported by the terminal device for electronic payment at the terminal device by other forms of local payment.

In another example, a user device 125 can trigger a virtual card payment by communicating with virtual card server system 105. Further, unique image data can be generated by virtual card server system 105 and sent to the terminal device 115 at the other side of the transaction. The image data can be displayed to the user device 125 (e.g., using display 226 of terminal device 115) and captured by the user device 125 (e.g. using image capturing device 246). The user device 125 can send the captured image data to the virtual card server system 105 for comparison with the image data sent to the terminal device 115 and authentication of the virtual card transaction if the image data sent to terminal device 115 matches the image data captured by the user device 125, among other potential examples. Again, authentication of the transaction can trigger communication between the virtual card emulated at the virtual card server system 105 and the terminal device 115 to complete the transaction according to a protocol supported by the terminal device 115, including legacy payment protocols and other example protocols.

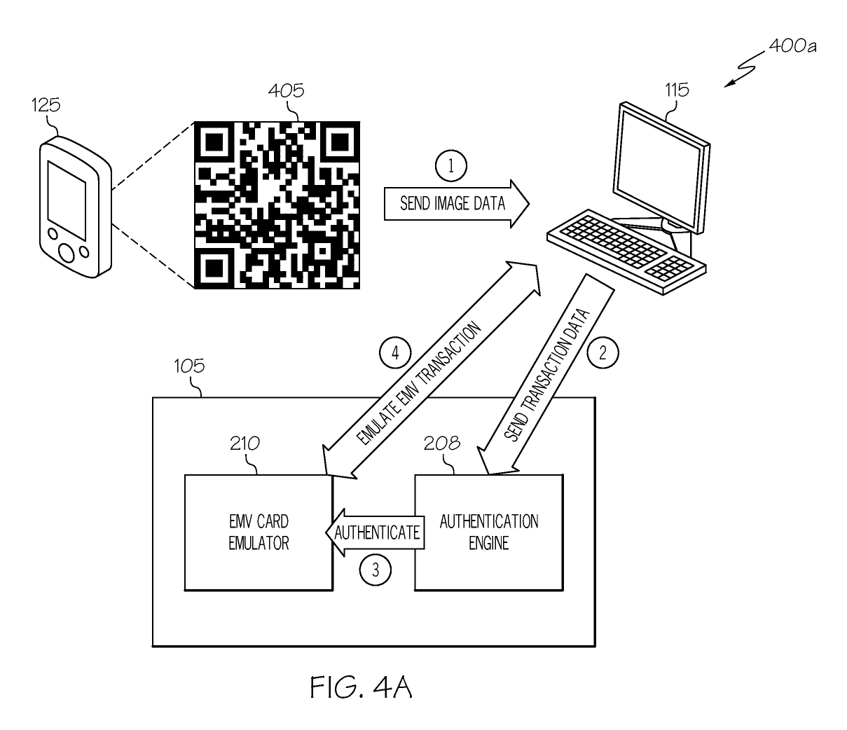

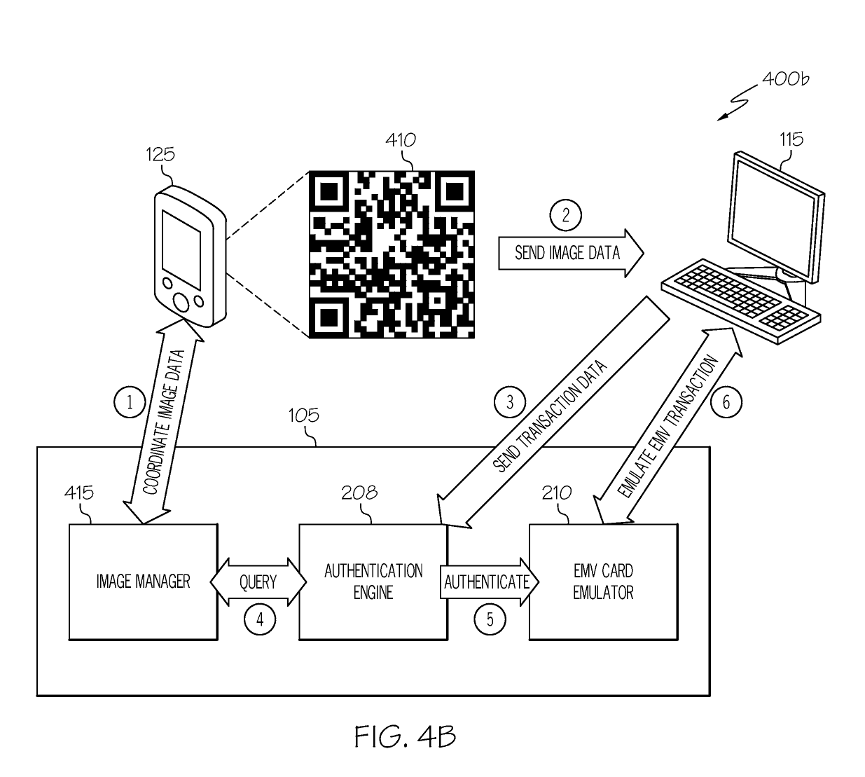

Turning now to the examples of FIGS. 4A-4B, simplified block diagrams 400a-400b illustrate example interactions between a user device, terminal device, and virtual card server system 105 in connection with payment using a virtual card hosted by the virtual card server system 105. In the particular example of FIG. 4A, a user device 125, such as a smartphone, can have a virtual card payment application installed thereon. In this example, the smartphone can be used to generate an image, such as a one or two-dimensional barcode, such as a QR code, MaxiCode, Semacode, High Capacity Color Barcode (HCCB), or other image, that can be displayed to the terminal device using the smartphone. The terminal device can capture the image using image capture capabilities (e.g., a digital camera) on the terminal device and can communicate transaction data to the virtual card server system 105 describing the transaction with the user of the smartphone together with the captured copy of the image evidencing that the terminal device is in legitimate contact with the user of the smartphone. The transaction can be authenticated (e.g., using authentication engine 208) passing control to a session emulator 210 capable of emulating an exchange between a virtualized version of a chip card and the remote terminal device over a network. For instance, an EMV-based transaction can be emulated.

In some instances, in the example of FIG. 4A, smartphone can be offline and still provide functionality for generating an image 405 that can be used as the basis of authenticating a virtual card transaction at a corresponding virtual card server system 105. Functionality for generating the image can be present on the smartphone itself. Further, the smartphone (or other communication device 125) can coordinate the use of images with virtual card server system 105. In one example, a pseudo-random sequence of images can be agreed upon between a virtual card payment application on the smartphone and the virtual card server system 105 and the virtual card server system 105 can expect that a particular image (or set of images) will be generated and used in connection with transactions involving the installation of the virtual card payment application on the smartphone. In another example, offline operation can be maintained by providing a shared secret between an installation of the virtual card payment application and the virtual card server system 105, such as a seed, can be provided for use in generating and decoding one-time-passwords encoded in the images generated by the smartphone for analysis by the virtual card server system 105 in determining whether to authenticate a transaction involving a particular terminal device (e.g., 115), among other potential examples.

Indeed, in one particular example, virtual card payment application can be installed on smartphone together with virtual card data. The virtual card data can include a specific card credential downloaded onto the phone (e.g., in secure storage, such as a secure element). The credential can serve as a “nominal card” containing information that identifies the card issuer, identification of the particular virtual card service and system hosting the virtual card, a primary account number (PAN) of the virtual card, a authentication information that enables a terminal to have a secure session with the virtual card server system, among other example information. In some cases, rather than including the PAN itself, the nominal card can include some other card identification data that can be mapped to or used to derive the actual PAN (e.g., using the virtual card payment application or at the virtual card server system) so as to keep sensitive card data from having to be stored on the communication device. The nominal card can further include one or more cryptographic secrets for use in generating image data corresponding to an account. For instance, the secret data can be packaged into a byte string (e.g., using any mechanism, such as XML, to pack structured data, among other examples). When access to the secret is authenticated, information included in the secret data can be unpacked and encoded in a QR code or other optical code, using standard encoding mechanisms for that type of code. The secret data can be stored, for instance, in a Secure Element of the device, or encrypted in application storage associated with the virtual card payment application or other memory (e.g., when a secure element is unavailable). In particular, if the secrets are stored in application storage they may be cryptographically camouflaged under a PIN or other authentication key (e.g., including biometric signatures, etc.). Indeed, access and use of such secret data can be preconditioned on a user authenticating access to the data using such authentication techniques as passwords, PINs, touchscreen swipe patterns, biometric data, and the like. Information included in the secret data to be encoded in the image data can include, for example, identification of the virtual card issuer and/or server, identification of a primary account number (PAN) or other identifier of the account, a session ticket, among other example information.

To initiate payment the user can enter a PIN into their mobile phone associated with the virtual card payment application installed on the phone. Entering the PIN can unlock the nominal card credentials that can be used to generate the image (e.g., 405). In some implementations, brute force attacks on the PIN can be mitigated through a maximum failed PIN attempts rule (e.g., a three strikes policy) or other mechanism to protect the payment application from hacks. The image generated from the credential (e.g., by the virtual card payment application) can be encoded to include one or more pieces of information from the credentials including, for example, the virtual card issuer identifier, virtual card server system identifier, the PAN or other virtual card account identifier, a session ticket (for a session between the terminal and the virtual card server system), among potentially other information.

In one example, upon reading the QR code or other image (e.g., 405) generated by the customer's communication device, the terminal can initiate a session with the virtual card server system over one or more networks using the session ticket. In some implementations, the session ticket can be a short-lived cryptographic credential, such as a Kerberos-style ticket, a SAML token, or other credential. The session ticket can have a predefined validity period and the period can be set to a relatively small interval, such as 60 seconds or less from the time of the ticket's generation or generation of the image data, to make it difficult for unscrupulous actors to steal or reuse the image data and masquerade as the terminal in an unauthorized transaction. Further security measures can be employed either through the session ticket characteristics or characteristics of the image data. For instance, in one example, image data can expire according to short intervals and regenerate (e.g., every 10 seconds) to generate batches of images and accommodate delay between the card member's launching the application and the readiness of the terminal in being able to read the image. In some implementations, gaps can be defined between regenerated images to avoid reading errors, among other examples.

The terminal can initiate an encrypted session with the virtual card server system using information (e.g., the session ticket) encoded in the image received from the customer's communication device. For instance, the terminal can present the ticket received in the image data to the virtual card server system and the virtual card server system can accept or reject the session based on the received session ticket. The virtual card server system can enforce single use of a given session ticket such that there are no parallel sessions utilizing the same ticket. Further, in instances where regeneration of image data is supported, the virtual card server system can check for attempted use of multiple tickets within a given batch of images. With the session established, the virtual card server system can emulate a transaction between the virtual card and the terminal similar to exchanges between the terminal and a local, physical card device at the terminal. For instance, rather than a terminal making calls to an NFC stack or other interface of a local card, the terminal can utilize an API or other interface to make similar call (e.g., according to EMV protocol) with the virtual card server system.

While at least some of the previous examples, including the example of FIG. 4A and the accompanying discussion, can enable generation of image data (e.g., 405) while the communication device (e.g., 125) and installed virtual card payment application are offline, other implementations can take advantage of network connectivity of a communication device 125. In some instances, the protocol employed can be based on detecting, at the communication device, whether (and what type) of network connectivity is available. For instance, a mobile broadband network connection may be considered more trustworthy than a public WiFi connection and “offline” virtual card mode (such as in FIG. 4A) can be employed when a suitable network connection is unavailable, among other examples. Turning to FIG. 4B, a smart phone can again generate image data (e.g., 410) from virtual card data (such as a private nominal card credential), but in this case, the smart phone 125 can negotiate the credential with the virtual payment processing system 105. This can allow, in some cases, more secure transactions and for less information to be encoded and shared in the image data 410. The image data (such as a session ticket) can be negotiated, for instance, with an image manager 415, of a virtual card server system and corresponding image data can be generated by a virtual card payment application on the smart phone 125 and presented to the terminal 115. Transaction data can be sent to the virtual card server system 105 along with the session ticket or other cryptographic data allowing a secure and authenticated session between the terminal and virtual card server system 105. Authentication engine 208 can authenticate that the proper image data was captured by the terminal 115 (e.g., from a session ticket extracted from the image data by the terminal) by querying records associated with the card holder, session key, etc. maintained, for instance, by image manager 415. Behavior of a card can then be virtualized by emulating (e.g., using EMV card emulator 210) messages exchanged between a card and the terminal 115, such as described above.

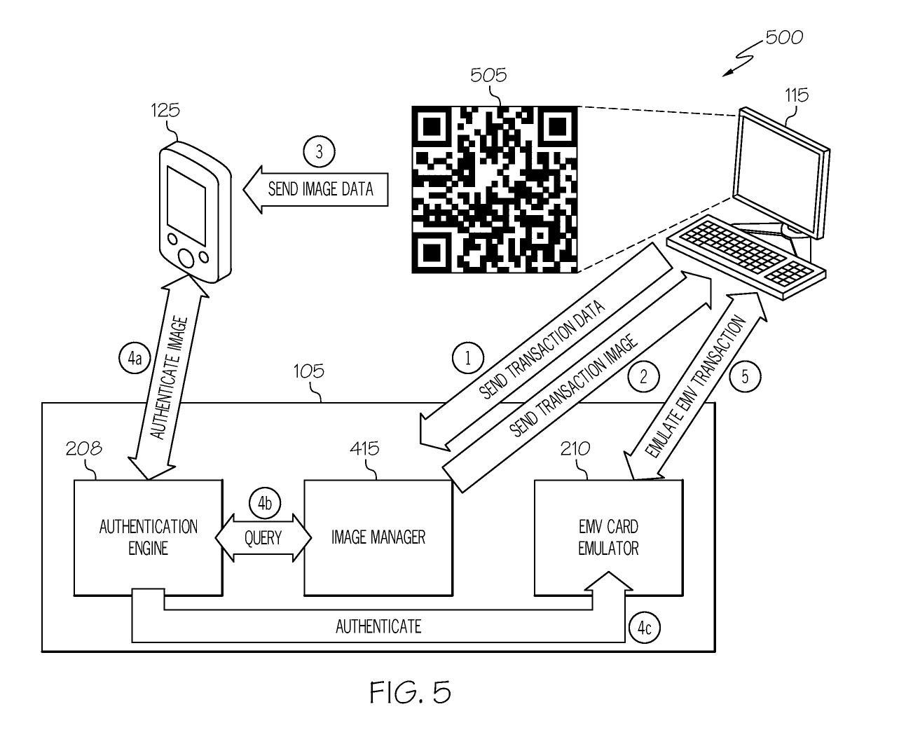

Turning to FIG. 5A, in some implementations, a terminal (e.g., 115) can initiate a transaction involving a virtual card holder (i.e., using communication device 125). In this example, a customer using smart phone 125 can indicate that they intend to pay (or otherwise use) a virtual card provided through a particular virtual card service (e.g., associated with virtual card server system 105). The terminal 115 can initiate communications with the virtual card server system 105 by sending some transaction data and the virtual card server system 105 can send image data to the terminal that corresponds to a particular transaction and session opened at the virtual card server system 105. The terminal 115 can then present the image data (e.g., 505) to the user and the user can utilize image capturing functionality on smart phone 125 to capture the image data. The image data can be similar to that generated by a virtual card payment application installed on user devices in other examples (e.g., the examples of FIGS. 4A-4B). The smart phone 125 can communicate the image (or data extracted from decoding of the image, such as a session ticket or other data) to the virtual card server system 105 as well as other data, such as cryptographic secret or other data (e.g., managed by a virtual card payment application on the smart phone 125) that can be used to by virtual card server system 105 to identify a virtual card account associated with the smart phone 125 (and installed virtual card payment application). The image (or session data) can be authenticated against image data that has been recently sent and is active (e.g., has not yet been associated with an authenticated virtual card payment application). If the data received from the smart phone 125 is determined to be authentic and correlates to data sent to the terminal 115, the transaction between the user of the smart phone 125 and terminal 115 can be authenticated, and the virtual card server system 105 can again engage in a session with the terminal 115 over a network and emulate an exchange between the terminal 115 and a card (or other payment device according to a protocol supported by the terminal).

In one implementation, in examples similar to that illustrated in FIG. 5, the image 505 can be encoded with information such as information identifying the particular terminal (e.g., 115) and a transaction or session identifier mapping the image to the current transaction, among potentially other data. The virtual card payment application can authenticate strongly to the virtual card server system in the session (e.g., using credentials on the corresponding user device), in order to ensure that the delegation of payment is from the legitimate cardholder. In some instances, the transaction identifier can also be signed like a ticket, in order to add extra security. The virtual card server system, upon authenticating the transaction based on data received from the user device, can open a secure session with the terminal and present the signed transaction identifier so that the terminal and virtual card server system know that they are completing the intended transaction (e.g., and not another transaction introduced by the terminal or currently open or handled by the virtual card server system, among other examples).

In the example of FIG. 5, the smart phone utilizes network connectivity. In this and other examples where network connectivity and communication between the user device (e.g., 125) and virtual card server system 105 is used, the virtual card server system 105 can send immediate confirmation that payment using the virtual card was successful (or, in some cases, unsuccessful). In examples, such as that described in connection with the example of FIG. 4A, the virtual card server system 105 can also send a message to an inbox of the virtual card payment application (or an email or other messaging account associated with the virtual card account) to alert the user of the transaction results as soon as network connectivity is again available, among other examples.

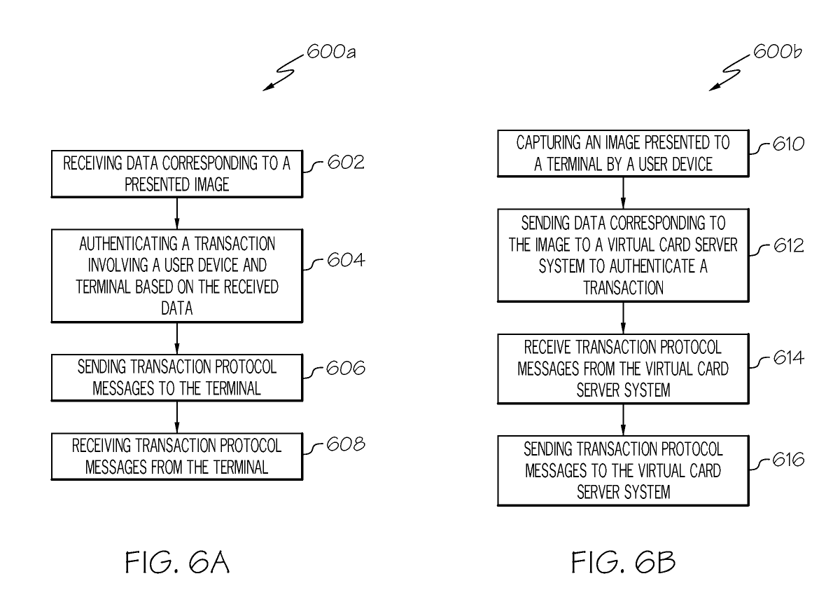

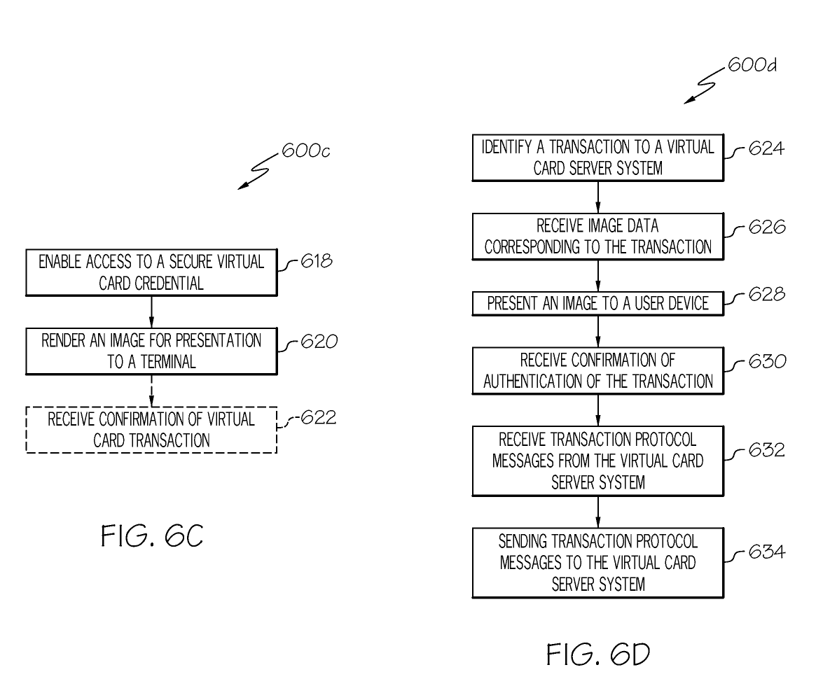

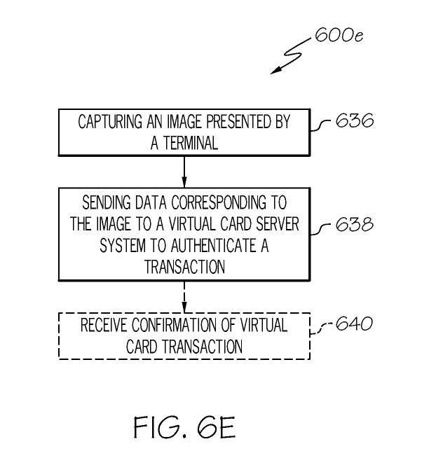

FIGS. 6A-6D are simplified flowcharts 600a-d illustrating example techniques relating to the performance of transactions using a virtual card hosted by a virtual card server system. In the example of FIG. 6A, data can be received 602 by a virtual card server system that corresponds to an image presented at a point-of-sale (or other location of a transaction involving a virtual card). The image can be presented in connection with a transaction involving a user device (or “user device”) of a user/virtual cardholder and a manned or unmanned terminal corresponding to a merchant, financial institution, etc. For instance, the image can be presented by the user device to the terminal and the terminal can send the data to the virtual card server system. In other instances, the image can be presented to the user device by the terminal and received 602 from the user device. The data can include information encoded in the image or even a copy of all or a portion of the image itself. The transaction between the user device and terminal can be authenticated 604 by the virtual card server system based on the received data. Authentication of the transaction can trigger involvement of the virtual card server system with the virtual card server system emulating a virtual payment instrument or device, such as a virtualization of a credit card, chip card, mobile computing device that includes chip card functionality, among other examples. The emulation of the payment device can involve the virtual card server system exchanging payment protocol messages with the terminal over one or more network, including those payment protocol messages that would be exchanged locally at the terminal were a physical payment device hosting a corresponding payment instrument presented and used by the user. A secure network connection (e.g., an SSL connection) can be established for the sending 606 of transaction protocol messages to and receiving 608 of transaction protocol messages from the terminal. The protocol messages can be predefined for use by particular payment instruments to complete transaction at the terminal.

Turning to FIG. 6B, in some implementations, a terminal (manned or unmanned) can capture 610 an image presented by a user device, such as on the display screen of a mobile computing device such as a tablet or smartphone. Data corresponding to the image can be sent 612 to a corresponding virtual card server system. In some cases, the image can be QR or other image-based code and can be encoded with information identifying the virtual card server system, the user of the user device, and a session (e.g., through a session key) for securely completing the transaction using the virtual card server system. The sent data can be used by the virtual card server system to authenticate the terminal's involvement in a transaction with a given virtual card member (and the associated virtual card account) and a secure communication session can be established over one or more networks between the virtual card server system and the terminal. The virtual card server system can emulate the behavior of one or more types of payment instruments that might otherwise presented using a payment device at the terminal as a method of payment through the exchange of transaction protocol messages within the secure session. Accordingly, the terminal can both receive 614 such transaction protocol messages from and send 616 transaction protocol messages to the virtual card server system to complete a transaction using a virtualization of a payment device.

Turning to the example of FIG. 6C, a virtual card payment application can be loaded on a user device together with a virtual card credential corresponding to a virtual card account. The application can enable the user device to initiate transactions that utilize the virtual card. The virtual card credential can be secured and use of the virtual card credential can be limited to the application and authorized users of the application (and virtual card account). Accordingly, in some implementations, access to the credential can be selectively enabled (e.g., at 618) by the application based, for instance, on a user authenticating themselves at the user device. For instance, the user may be prompted for a PIN, password, voice sample, or other biometric data that can be captured using the user device in connection with enabling 618 use of the credential. The credential can be used in connection with the generation and rendering 620 of an image at the user device for presentation to a terminal to initiate a transaction utilizing the virtual card. For instance, information in the credential can be encoded in the image or be used as a secret to encode passwords, keys, or other identifiers in the image, among other examples. In some instances, the user device can receive directions from the virtual card server system over one or more networks that influence what image is presented at the user device in connection with a transaction. The credentials can be used in such instances to authenticate the user device to the virtual card server system. In some instances, the virtual card server system can send image data to the user device to be rendered for presentation at the user device. In some cases, data received from the virtual card server system can be combined with information included in the credential to generate an image or information encoded in the image, among other examples. Upon presenting the image to the terminal, a user may wait on the subsequent interactions between the terminal and virtual card server system before being notified of the success or failure of the transaction. In some cases, visibility into such interactions can be provided to the user through the virtual card payment application on the user device and communications received by the user device from the virtual card server system. For example, in cases where the user device has network connectivity, a confirmation of the successful completion of the transaction using the virtual card can be received 622 at the user device, among other examples.

In some implementations, a terminal may present an image to the user device in connection with the initiation of a virtual card transaction. For instance, in the example of FIG. 6D, a transaction between the terminal and user of a user device can be identified 624 to a virtual card server system corresponding to a virtual card account of the user. For example, the transaction can be identified in the form of a request for a transaction authentication image in connection with the transaction, among other examples. Image data can be received 626, at the terminal, corresponding to the transaction. The terminal can render the image data to present 628 an image to the user device. The user device can share information obtained from the image to authenticate the transaction with the virtual card server system. The virtual card server system can confirm (e.g., at 630) authentication of the transaction with the terminal, for instance, by initiating or granting a secure session with the terminal over one or more networks to emulate a local transaction with a locally-presented payment device through the exchange of transaction protocol messages (e.g., at 632 and 634) between the terminal and the remote virtual card server system.

Turning to the example of FIG. 6E, in instances where the terminal presents the transaction authentication image to the user device, the user device can capture 636 the image and send 638 data to the virtual card server system corresponding to the image. The data can describe information decoded from the image or can include copied portions of the image as captured by the user device. In some cases, the terminal may be unable to decode or make use of some information included or encoded in the image, as the image, as provided through the virtual card server system, can be particularly adapted to be decoded by a corresponding virtual card payment application installed on the user device, among other potential implementations. The virtual card server system can use the data sent 638 by the user device to authenticate the corresponding transaction initiated between the terminal (i.e., to which the image data was initially sent) and the data corresponding to the image sent 638 from the user device. Optionally, the virtual card server system can provide information to the user device reporting on the status of the authentication or protocol progress of a transaction as the virtual card server system emulates the payment device over a secure network communication channel with the terminal. For instance, the user device can receive 640, from the virtual card server system, confirmation of the completion of the virtual card transaction, among other examples.

The flowcharts and block diagrams in the Figures illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

1. A method comprising:
receiving, at a virtual card system comprising a data processing apparatus, data from a user device describing a computer-generated image captured by the user device as presented to the user device using a display device of a terminal device at a location of a transaction involving the user device and the terminal device;
determining, at the virtual card system, that the user device and the terminal device are engaged in the transaction and that the user device is used to pay for the transaction based at least in part on the data; and
virtualizing, at the virtual card system, local interactions of a payment device with the terminal device based on authenticating the transaction, wherein virtualizing the interactions comprises the virtual card system exchanging messages with the terminal device over a network according to a protocol corresponding to the payment device and the terminal device.

2. The method of claim 1, wherein the data comprises a session ticket encoded within the image.

3. The method of claim 2, wherein the data further comprises an identifier of a virtual card account associated with the user device.

4. The method of claim 1, wherein the data comprises a copy of the image.

5. (canceled)

6. The method of claim 1, wherein the terminal device comprises a point-of-sale terminal.

7. The method of claim 1, wherein the user device comprises a smartphone.

8. (canceled)

9. (canceled)

10. The method of claim 1, wherein the messages comprises messages according to the EMV protocol.

11. The method of claim 1, wherein local interactions of a payment card are to be virtualized.

12. A method comprising:
sending transaction data from a terminal device to a virtual card server system over a network, wherein the transaction data comprises a transaction identifier to identify a transaction involving a user device and the terminal device;
receiving image data from the virtual card server system at the terminal device, wherein the image data corresponds to the transaction;
rendering a particular image from the image data for presentation to the user device using a display device of the terminal device;
identifying that the user device has authenticated to the transaction based on the particular image; and
exchanging messages with the virtual card server system over a network to complete the transaction according to a protocol corresponding to a card device emulated by the virtual card server system based on identifying that the user device has authenticated to the transaction, wherein the card device is associated with the user device based on the authentication of the user device.

13. (canceled)

14. (canceled)

15. The method of claim 12, wherein the image data corresponds to a session associated with the transaction.

16. The method of claim 15, wherein session identification information is encoded in the image and the method further comprises decoding the image to identify the authentication of the user device is based on the user device providing the session identification information to the virtual card server system.

17. (canceled)

18. The method of claim 12, wherein the image is encoded with information identifying the transaction and the user device is to communicate the information to the virtual card server system to authenticate to the transaction.

19. The method of claim 12, wherein the messages comprise:
application selection messages;
initiate application processing messages;
offline data authentication messages;
processing restrictions messages;
cardholder verification messages;
terminal risk management messages;
terminal action analysis messages; and
card action analysis messages.

20. A computer program product comprising a computer readable storage medium comprising computer readable program code embodied therewith, the computer readable program code comprising:
computer readable program code configured to receive, at a virtual card system comprising a data processing apparatus, data from a user device describing computer-generated image presented to the user device using a display device of a terminal device at a location of a transaction involving the user device and the terminal device;
computer readable program code configured to determine, from the data, that the user device and the terminal device are engaged in the transaction and that the user device is used to pay for the transaction; and
computer readable program code configured to virtualize, at the virtual card system, local interactions of a payment device with the terminal device based on authenticating the transaction, wherein virtualizing the interactions comprises the virtual card system exchanging messages with the terminal device over a network according to a protocol corresponding to the payment device and the terminal device.

21. A computer program product comprising a computer readable storage medium comprising computer readable program code embodied therewith, the computer readable program code comprising:
computer readable program code configured to send transaction data from a terminal device to a virtual card server system over a network, wherein the transaction data comprises a transaction identifier to identify a transaction involving a user device and the terminal device.
computer readable program code configured to receive image data from the virtual card server system at the terminal device, wherein the image data corresponds to the transaction;
computer readable program code configured to render a particular image from the image data for presentation to the user device using a display device of the terminal device;
computer readable program code configured to identify that the user device has authenticated to the transaction based on the particular image; and
computer readable program code configured to exchange messages with the virtual card server system over a network to complete the transaction according to a protocol corresponding to a card device emulated by the virtual card server system based on identifying that the user device has authenticated to the transaction, wherein the card device is associated with the user device based on the authentication of the user device.

22. A system comprising:
a processor device;
a memory element;
a virtual card server system to:
receive data from a user device describing a computer-generated image captured by the user device during presentation of the image to the user device by a display device of a terminal device at a location of a transaction involving the user device and the terminal device;
determine that the user device and the terminal device are engaged in the transaction and that the user device is used to pay for the transaction based at least in part on the data; and
virtualize local interactions of a payment device with the terminal device based on authenticating the transaction, wherein virtualizing the interactions comprises the virtual card server system exchanging messages with the terminal device over a network according to a protocol corresponding to the payment device and the terminal device.

23. The system of claim 22, further comprising the user device, wherein the user device comprises secure credential data.

24. (canceled)

25. The system of claim 23, wherein the user device is to capture the image as generated by the terminal device and send the data corresponding to the image to the virtual card server system.
